(19) United States
(12) Patent Application Publication
(10) Pub. No.: US 2023/0005303 A1
(43) Pub. Date: Jan. 5, 2023

(54) ROADSIDE UNIT, ON-BOARD UNIT, COMMUNICATION SYSTEM, AND COMMUNICATION METHOD

(71) Applicant: Panasonic Intellectual Property Management Co., Ltd., Osaka (JP)

(72) Inventors: Akihiro EGAMI, Tokyo (JP); Hiroyuki MOTOZUKA, Kanagawa (JP); Takenori SAKAMOTO, Kanagawa (JP)

(21) Appl. No.: 17/939,726

(22) Filed: Sep. 7, 2022

Related U.S. Application Data
(63) Continuation of application No. PCT/JP2020/040207, filed on Oct. 27, 2020.

(30) Foreign Application Priority Data
Mar. 11, 2020 (JP) 2020-042246

(51) Int. Cl. G07C 5/00; H04W 76/19; H04W 4/44

(52) U.S. Cl. CPC G07C 5/008; H04W 76/19; H04W 4/44

(57) ABSTRACT

Provided is a roadside unit including: communication circuitry, which, in operation, receives data transmitted from an on-board unit and transfers the data to a server; and control circuitry, which, in operation, suspends, in a case where the communication circuitry has received an upload resume request for the data from the on-board unit while the data is being transferred to the server, transfer of the upload resume request to the server.

### TECHNICAL FIELD

The present disclosure relates to a roadside unit, an on-board unit, a communication system, and a communication method.

### BACKGROUND ART

In recent years, Intelligent Transport Systems (ITS) that transmit and receive information among apparatuses, such as an on-board unit mounted in a vehicle, a roadside unit installed on the road, and a server, have been put into practical use.

Note that, Patent Literature (hereinafter referred to as “PTL”) 1 discloses a method of making it unnecessary to retransmit data having been transmitted once from a cellular phone in a case where line disconnection occurs while the data is being uploaded from the cellular phone to a web server.

### CITATION LIST

### Patent Literature

### PTL 1

Japanese Patent Application Laid-Open No. 2008-271097

### SUMMARY OF INVENTION

### Technical Problem

In a case where communication disconnection occurs between an on-board unit and a roadside unit, the communication is then restored, and the on-board unit performs data re-uploading, the data volume transmitted by the on-board unit to the roadside unit before the communication disconnection may differ from the data volume transferred by the roadside unit to a server. Accordingly, the data in the on-board unit may not be uploaded to the server appropriately.

One non-limiting and exemplary embodiment of the present disclosure facilitates providing a roadside unit capable of uploading data in an on-board unit appropriately.

A roadside unit according to one exemplary embodiment of the present disclosure includes: communication circuitry, which, in operation, receives data transmitted from an on-board unit and transfers the data to a server; and control circuitry, which, in operation, suspends, in a case where the communication circuitry has received an upload resume request for the data from the on-board unit while the data is being transferred to the server, transfer of the upload resume request to the server.

An on-board unit according to one exemplary embodiment of the present disclosure includes: communication circuitry, which, in operation, performs communication with a roadside unit including: transfer circuitry, which, in operation, receives data and transfers the data to a server; and control circuitry, which, in operation, suspends, in a case where an upload resume request for the data has been received from the on-board unit while the data is being transferred to the server, transfer of the upload resume request to the server; and control circuitry, which, in operation, configures, after the communication with the roadside unit is disconnected, a transmission interval of the upload resume request to be longer than a transmission interval of the upload resume request before the communication with the roadside unit is disconnected.

A communication system according to one exemplary embodiment of the present disclosure includes: an on-board unit; and a roadside unit. The on-board unit includes: on-board unit communication circuitry, which, in operation, transmits data; and on-board unit control circuitry, which, in operation, transmits an upload resume request for the data. The roadside unit includes: roadside unit communication circuitry, which, in operation, receives the data and transfers the data to a server; and roadside unit control circuitry, which, in operation, suspends, in a case where the upload resume request for the data has been received while the data is being transferred to the server, transfer of the upload resume request to the server.

A communication method according to one exemplary embodiment of the present disclosure includes: receiving data transmitted from an on-board unit; transferring the data to a server; and suspending, in a case where an upload resume request for the data has been received from the on-board unit while the data is being transferred to the server, transfer of the upload resume request to the server.

It should be noted that general or specific embodiments may be implemented as a system, a method, an integrated circuit, a computer program, a storage medium, or any selective combination thereof.

According to one exemplary embodiment of the present disclosure, it is possible to upload data in an on-board unit appropriately.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of a communication system according to an embodiment of the present disclosure;

FIG. 2 illustrates an example of a block configuration of an on-board unit;

FIG. 3 illustrates an example of a block configuration of a roadside unit;

FIG. 4 illustrates an example of a block configuration of a server;

FIG. 5 is a sequence diagram illustrating an operation example of the communication system;

FIG. 6 illustrates a flowchart for an operation example of the roadside unit;

FIG. 7A is a sequence diagram illustrating an operation example of the communication system of FIG. 1;

FIG. 7B is a sequence diagram illustrating the operation example of the communication system of FIG. 1;

FIG. 8A is a sequence diagram illustrating an operation example of the communication system of FIG. 1;

FIG. 8B is a sequence diagram illustrating the operation example of the communication system of FIG. 1;

FIG. 9A is a sequence diagram illustrating an operation example of the communication system of FIG. 1;

FIG. 9B is a sequence diagram illustrating the operation example of the communication system of FIG. 1;

FIG. 10A is a sequence diagram illustrating an operation example of the communication system of FIG. 1;

FIG. 10B is a sequence diagram illustrating the operation example of the communication system of FIG. 1;

FIG. 11 is a sequence diagram illustrating an operation example of the communication system of FIG. 1;

FIG. 12 is a sequence diagram illustrating an operation example of the communication system of FIG. 1;

FIG. 13A is a sequence diagram illustrating an operation example of the communication system of FIG. 1; and

FIG. 13B is a sequence diagram illustrating the operation example of the communication system of FIG. 1.

### DESCRIPTION OF EMBODIMENTS

Hereinafter, embodiments of the present disclosure will be described in detail with reference to the accompanying drawings as appropriate. However, a detailed description more than necessary may be omitted, such as a detailed description of a well-known matter and a duplicate description for a substantially identical configuration, to avoid unnecessary redundancy of the following description and to facilitate understanding by a person skilled in the art.

Note that, the accompanying drawings and the following description are provided for a person skilled in the art to understand the present disclosure sufficiently, and are not intended to limit the subject matter recited in the claims.

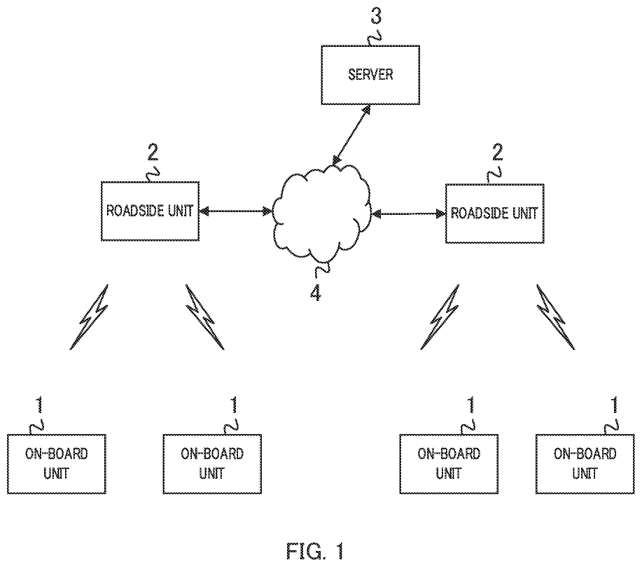

FIG. 1 illustrates a configuration example of a communication system according to an embodiment of the present disclosure. As illustrated in FIG. 1, the communication system includes on-board unit 1, roadside unit 2, and server 3.

On-board unit 1 is mounted in, for example, a vehicle such as an automobile and a motorcycle. On-board unit 1 performs radio communication with roadside unit 2.

On-board unit 1 includes various sensors. On-board unit 1 transmits data collected by using the various sensors to roadside unit 2. For example, on-board unit 1 transmits camera image data, position data acquired by using a global positioning system (GPS), and radar data to roadside unit 2.

Roadside unit 2 is installed in, for example, a structure such as a traffic light, a street light, or a utility pole. Roadside unit 2 forms, for example, a communication area on the road and at an intersection, through which a vehicle passes. Roadside unit 2 performs radio communication with on-board unit 1 in the communication area, and transfers data transmitted from onboard unit 1 to server 3. Further, roadside unit 2 transfer data received from server 3 to roadside unit 2. The transfer may also be referred to as transmission.

Roadside unit 2 is connected to server 3 through network 4. Network 4 may be, for example, the Internet. Network 4 may include a radio network.

Server 3 communicates with roadside unit 2. Further, server 3 communicates with on-board unit 1 through roadside unit 2. Server 3 collects various data uploaded from on-board unit 1 and stores the various data in a storage apparatus. Server 3 processes the various data stored in the storage apparatus and transmits a processing result to on-board unit 1. The uploading may also be referred to as transmission.

Note that, the number of on-board units 1, the number of roadside units 2, and the number of servers 3 are not limited to the examples in FIG. 1.

Further, for example, a plurality of roadside units 2 may be installed at one intersection. Further, one roadside unit 2 may form communication areas for a plurality of intersections.

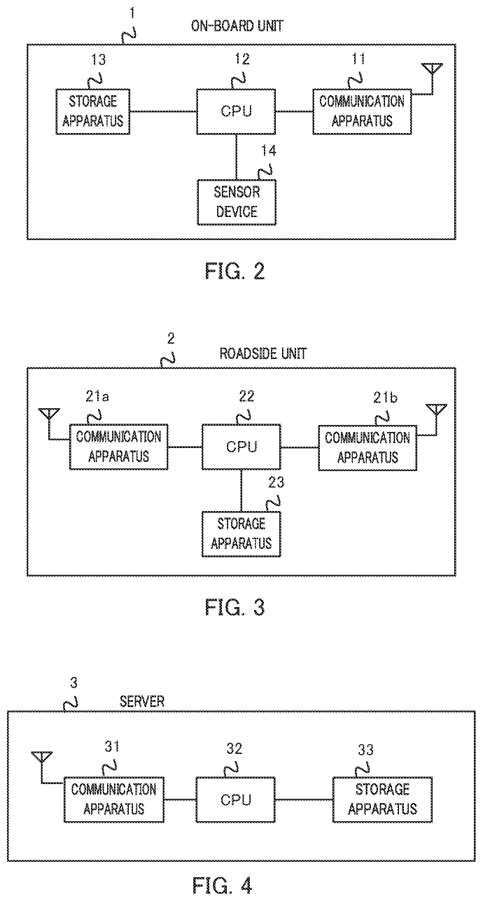

FIG. 2 illustrates an example of a block configuration of on-board unit 1. As illustrated in FIG. 2, on-board unit 1 includes communication apparatus 11, central processing unit (CPU) 12, storage apparatus 13, and sensor device 14.

Communication apparatus 11 performs radio communication with roadside unit 2. For example, communication apparatus 11 performs radio communication with roadside unit 2 based on wireless gigabit (WiGig). Further, communication apparatus 11 may also perform radio communication with roadside unit 2 based on dedicated short range communication (DSRC), cellular-V2X (C-V2X), a wireless local area network (LAN), worldwide interoperability for microwave access (WiMAX), 4th Generation (4G) or 5th Generation (5G). Communication apparatus 11 may also be referred to as a communicator.

CPU 12 controls on-board unit 1 in its entirety. CPU 12 may also be referred to as a controller. CPU 12 transmits data outputted from sensor device 14 to roadside unit 2 through communication apparatus 11.

Storage apparatus 13 stores a program for CPU 12 to operate. Further, storage apparatus 13 stores data for CPU 12 to perform calculation processing, data for CPU 12 to control each section, and the like. Storage apparatus 13 may be formed of storage apparatuses such as a random access memory (RAM), a read only memory (ROM), a flash memory, and a hard disk drive (HDD).

Sensor device 14 is, for example, a sensor device such as a camera, a radar, light detection and ranging (LiDAR), a sonar, and an ultrasonic sensor. Sensor device 14 may include an electronic control unit (ECU).

Note that, on-board unit 1 may not include sensor device 14. Sensor device 14 may be provided in a vehicle.

FIG. 3 illustrates an example of a block configuration of roadside unit 2. As illustrated in FIG. 3, roadside unit 2 includes communication apparatuses 21a and 21b, CPU 22, and storage apparatus 23.

Communication apparatus 21a performs radio communication with on-board unit 1. For example, communication apparatus 11 performs radio communication with on-board unit 1 based on DSRC. Communication apparatus 21a may also be referred to as a communicator.

Communication apparatus 21b performs wired communication with server 3.

Communication apparatus 21b may also perform radio communication with server 3. Note that, communication apparatus 21b may also be referred to as a communicator.

CPU 22 controls roadside unit 2 in its entirety. CPU 22 may also be referred to as a controller. CPU 22 transmits data in on-board unit 1 received by communication apparatus 21a to server 3 through communication apparatus 21b. CPU 22 transmits data in server 3 received by communication apparatus 21b to on-board unit 1 through communication apparatus 21a.

Storage apparatus 23 stores a program for CPU 22 to operate. Further, storage apparatus 23 stores data for CPU 22 to perform calculation processing, data for CPU 22 to control each section, and the like. Storage apparatus 23 may be formed of storage apparatuses such as a RAM, a ROM, a flash memory, and an HDD. Note that, storage apparatus 23 may also accumulate data in on-board unit 1 received by communication apparatus 21a and/or data in server 3 received by communication apparatus 21b.

FIG. 4 illustrates an example of a block configuration of server 3. As illustrated in FIG. 4, server 3 includes communication apparatus 31, CPU 32, and storage apparatus 33.

Communication apparatus 31 performs wired communication with roadside unit 2. Note that, communication apparatus 31 may also communicate with roadside unit 2 through a radio network using a wireless LAN, WiMAX, 4G or 5G, for example. Further, communication apparatus 31 may also be referred to as a communicator.

CPU 32 controls server 3 in its entirety. CPU 32 may also be referred to as a controller. CPU 32 stores data in roadside unit 2 (on-board unit 1) received by communication apparatus 31 in storage apparatus 33. CPU 32 transmits a processing result obtained by processing using the data stored in storage apparatus 33 to roadside unit 2 through communication apparatus 31.

Storage apparatus 33 stores a program for CPU 32 to operate. Further, storage apparatus 33 stores data for CPU 32 to perform calculation processing, data for CPU 32 to control each section, and the like. Further, storage apparatus 33 stores data transmitted from on-board unit 1. Storage apparatus 33 that stores data in on-board unit 1 may also be referred to as a data base. Storage apparatus 33 may be formed of storage apparatuses such as a RAM, a ROM, a flash memory, and an HDD.

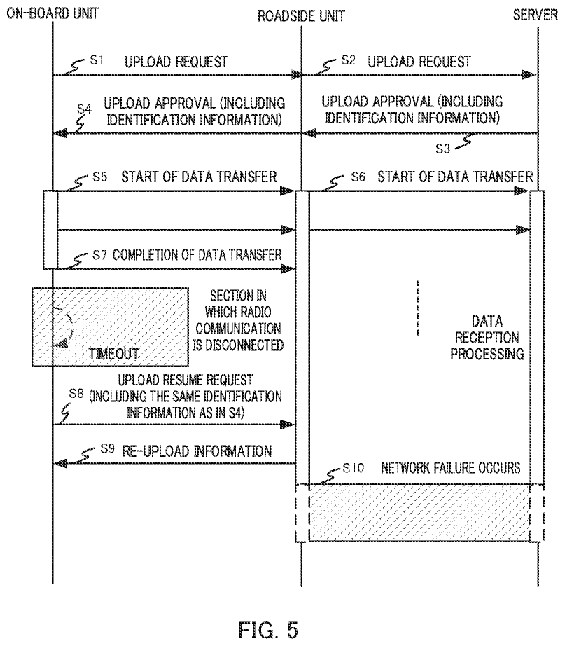

FIG. 5 is a sequence diagram illustrating an operation example of the communication system. The on-board unit transmits an upload request to the roadside unit (S1).

The roadside unit transfers the upload request in S1 to the server (S2).

The server transmits an upload approval to the roadside unit in accordance with the reception of the upload request in S2 (S3). The upload approval may include identification information assigned by the server. The identification information refers to information for identifying data uploaded from the on-board unit.

The roadside unit receives the upload approval transmitted in S3. The roadside unit registers the identification information (stores the identification information in the storage apparatus) included in the received upload approval, and transfers the upload approval including the identification information to the on-board unit (S4).

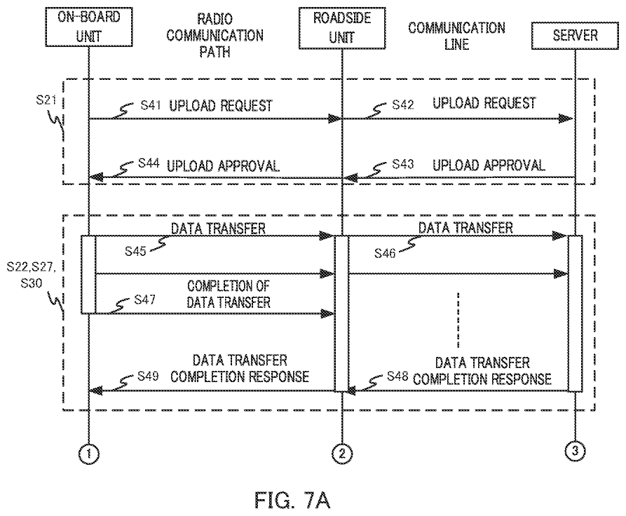

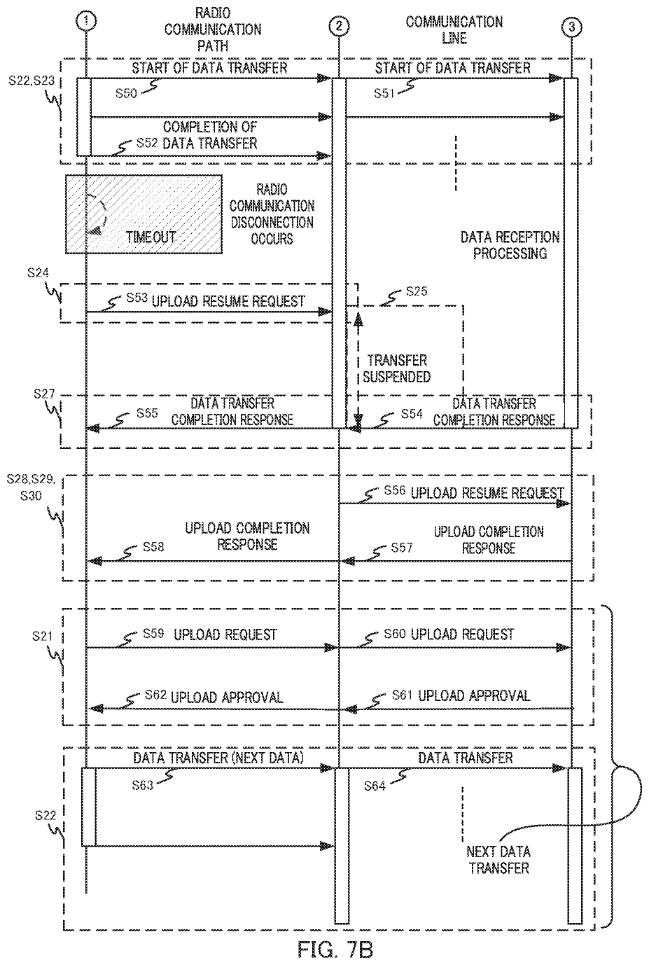

Note that, the roadside unit manages data volumes received from the on-board unit for each identification information. That is, the roadside unit distinguishes data received from the on-board unit for each communicate session and manages data volumes for each communicate session. Note that, the communication session is one unit for managing communication from start to end. For example, in the present embodiment, the communication session is a unit for the transmission of an upload approval, to which identification information is assigned, by the roadside unit to the on-vehicle unit (S4 in FIGS. 5 and S44 in FIG. 7A) through an upload completion response (S58 in FIG. 7B) by the roadside unit to the on-board unit, where the upload completion response indicates the completion of uploading of data to be managed with identical identification information.

The on-board unit transfers (uploads) the data to the roadside unit in accordance with the reception of the upload approval in S4 (S5).

The roadside unit receives the data uploaded by the roadside unit and transfers (starts to transfer) the data to the server (S6).

The on-board unit completes the data transfer (S7).

Note that, the data transfer between the roadside unit and the server is not completed at the time when the on-board unit completes the data transfer. For example, as illustrated in FIG. 5, when the communication speed between the roadside unit and the server is slower than the communication speed between the on-board unit and the roadside unit, a case where the uploading by the on-board unit is completed and the uploading (transfer) by the roadside unit is not completed occurs.

Here, the radio communication between the on-board unit and the roadside unit is disconnected while the on-board unit does not receive a response (data transfer completion response) to the completion of the data transfer in S7. The on-board unit times out the data transfer processing during the radio communication disconnection. The on-board unit transmits an upload resume request to the roadside unit in a case where the on-board unit times out the data transfer processing, but the on-board unit does not transmit an upload resume request since the radio communication is being disconnected.

The on-board unit transmits an upload resume request to the roadside unit after the radio communication between the on-board unit and the roadside unit is restored (S8). The upload resume request includes the identification information transmitted in S4.

The roadside unit receives the upload resume request transmitted in S8. The roadside unit acquires, from storage apparatus 23, a received data volume in the data data-transferred from the on-board unit corresponding to the identification information included in the received upload resume request.

For example, it is assumed that the on-board unit transmits data of N bytes to the roadside unit in the completion of the data transfer in S7. In this case, the roadside unit acquires information on the N bytes as information on a received data volume.

The roadside unit transmits re-upload information to the on-board unit in accordance with the reception of the upload resume request in S8 (S9). The re-upload information includes a received data volume. For example, in the case of the aforementioned example, the re-upload information includes the information on the N bytes.

After the start of the data transfer in S6, a failure occurs in the network between the roadside unit and the server (S10). It is assumed that the roadside unit has not completed the transfer of the data in the on-board unit at the time when the failure occurs in the network. For example, it is assumed that the roadside unit has transferred M byte(s) (M<N) of the data received from the on-board unit to the server at the time when the failure occurs in the network.

In the sequence of FIG. 5, in a case where the roadside unit has received the upload resume request in S8, the roadside unit transmits the re-upload information including the information on the received data volume of N bytes to the on-board unit (S9). After the on-board unit has received the re-upload information in S9, the on-board unit may resume the uploading from data of the N+1-th byte (not illustrated).

On the other hand, although the roadside unit transfers the data of M byte(s) to the server, there is also data that is not transferred to the server. For example, in the sequence of FIG. 5, there is data of “N−M” byte(s), where the data is not transferred to the server. For example, in a case where the communication speed between the roadside unit and the server is slower than the communication speed between the on-board unit and the roadside unit, data that is not transferred to the server may occur.

The communication system illustrated in FIG. 1 performs the following operations in order to re-upload data in on-board unit 1 to server 3 appropriately.

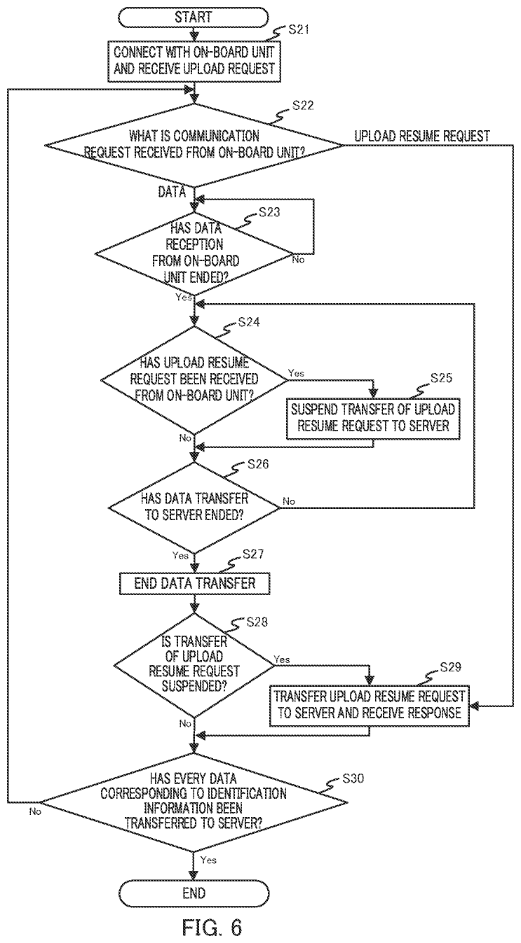

FIG. 6 illustrates a flowchart for an operation example of roadside unit 2. The operation starts by a vehicle, in which on-board unit 1 is mounted, entering the communication area of roadside unit 2. Note that, on-board unit 1 includes data to be uploaded to server 3.

Roadside unit 2 connects with on-board unit 1 by radio communication and receives an upload request from on-board unit 1 (S21).

Note that, roadside unit 2 transfers the upload request received from on-board unit 1 to server 3. In a case where server 3 has received the upload request by roadside unit 2, server 3 transmits identification information to roadside unit 2. The identification information includes the data size of data to be uploaded from on-board unit 1 to server 3. Roadside unit 2 registers the identification information transmitted from server 3 (stores the identification information in storage apparatus 23) and transmits the identification information to on-board unit 1.

Roadside unit 2 determines whether a communication request received from on-board unit 1 is uploading of data or an upload resume request (S22).

In a case where roadside unit 2 determines in S22 that the communication request received from on-board unit 1 is uploading of data (“DATA” in S22), roadside unit 2 determines whether the upload data reception from on-board unit 1 has ended (S23).

Note that, the end of the data reception from on-board unit 1 may include a case where the reception of every data from on-board unit 1 is completed. Further, the completion of the data reception from on-board unit 1 may also include, for example, a case where the data reception from on-board unit 1 is interrupted by radio communication disconnection.

In a case where roadside unit 2 determines in S23 that the data reception from on-board unit 1 has not ended (“No” in S23), roadside unit 2 repeats the processing in S23.

In a case where roadside unit 2 determines in S23 that the data reception from on-board unit 1 has ended (“Yes” in S23), roadside unit 2 determines whether an upload resume request has been received from on-board unit 1 (S24).

In a case where roadside unit 2 determines in S24 that an upload resume request has been received from on-board unit 1 (“Yes” in S24), roadside unit 2 suspends the transfer of the upload resume request to server 3 (S25).

In a case where roadside unit 2 determines in S24 that an upload resume request has not been received from on-board unit 1 (“No” in S24) or in a case where roadside unit 2 has suspended the transfer of the upload resume request to server 3 in S25, roadside unit 2 determines whether upload data transfer to server 3 has ended (S26).

Note that, the end of the data transfer to server 3 may include a case where the transfer of every data by roadside unit 2 is completed. Further, the end of the data transfer to server 3 may also include, for example, a case where the data transfer by roadside unit 2 is interrupted by communication disconnection of network 4.

In a case where roadside unit 2 determines in S26 that the data transfer to server 3 has not ended (“No” in S26), roadside unit 2 shifts the processing to S24.

In a case where roadside unit 2 determines in S26 that the data transfer to server 3 has ended (“Yes” in S26), roadside unit 2 ends the data transfer to server 3 (S27).

Note that, in a case where server 3 has completed the reception (uploading) of the data in on-board unit 1, server 3 may transmit a response to on-board unit 1 through roadside unit 2. The response may conform to, for example, Hypertext Transfer Protocol (HTTP) Status Code 200.

Roadside unit 2 determines whether the transfer of the upload resume request is suspended (S28).

In a case where roadside unit 2 determines in S28 that the transfer of the upload resume request is suspended (“Yes” in S28), roadside unit 2 transfers the upload resume request to server 3 and receives a response to the upload resume request from server 3 (S29). Further, in a case where roadside unit 2 determines in S22 that the communication request received from on-board unit 1 is an upload resume request (“UPLOAD RESUME REQUEST” in S22), roadside unit 2 transfers the upload resume request to server 3 and receives a response to the upload resume request from server 3 (S29).

Note that, the response by server 3 may conform to, for example, HTTP Status Code 200 or 100.

Further, for example, in a case where roadside unit 2 does not receive a response from server 3 due to disconnection of network 4, roadside unit 2 may transmit an error notification in conformity with HTTP Status Codes 5xx to on-board unit 1.

In a case where roadside unit 2 determines in S28 that the transfer of the upload resume request is not suspended (“No” in S28), roadside unit 2 determines whether every data corresponding to the identification information has been transferred to server 3 (S30). Further, in a case where roadside unit 2 receives a response to the upload resume request from server 3 in S29 (S29), roadside unit 2 determines whether every data corresponding to the identification information has been transferred to server 3 (S30).

In a case where roadside unit 2 determines in S30 that every data corresponding to the identification information has not been transferred to server 3 (“No” in S30), roadside unit 2 shifts the processing to S22.

In a case where roadside unit 2 determines in S30 that every data corresponding to the identification information has been transferred to server 3 (“Yes” in S30), roadside unit 2 ends the processing of the flowchart.

FIGS. 7A and 7B are sequence diagrams illustrating an operation example of the communication system of FIG. 1. The sequence illustrated in FIG. 7A is followed by the sequence of FIG. 7B. The reference signs for the dotted frames illustrated in FIGS. 7A and 7B correspond to the operations of the reference signs illustrated in FIG. 6. For example, dotted frame S21 illustrated in FIGS. 7A and 7B corresponds to the operation in S21 illustrated in FIG. 6.

The sequences illustrated in FIGS. 7A and 7B illustrate an operation example in a case where radio communication disconnection occurs on the radio communication path between on-board unit 1 and roadside unit 2 when a second block of data D1 is uploaded after uploading of a first block of data D1 from on-board unit 1 to roadside unit 2 has been completed (see the hatched part in FIG. 7B). Further, the sequences illustrated in FIGS. 7A and 7B indicate an operation example in a case where roadside unit 2 is performing data transfer to server 3 when roadside unit 2 receives an upload resume request from on-board unit 1 (see S53 in FIG. 7B).

The operation starts by a vehicle, in which on-board unit 1 is mounted, entering the communication area of roadside unit 2. Note that, on-board unit 1 includes data to be uploaded to server 3.

On-board unit 1 connects with roadside unit 2 by radio communication and transmits an upload request for the first-block of data D1 to roadside unit 2 (S41).

Roadside unit 2 transfers the upload request in S41 to server 3 (S42).

Server 3 transmits an upload approval to roadside unit 2 in accordance with the reception of the upload request in S42 (S43).

Roadside unit 2 transfers the upload approval in S43 to on-board unit 1 (S44).

Note that, the upload approval includes identification information assigned by server 3. The identification information refers to information for identifying data uploaded from on-board unit 1. The identification information includes information on the data size of data to be uploaded in its entirety (hereafter, the data size may also be referred to as the UL data size).

Further, on-board unit 1 may divide the data (data D1) to be uploaded to server 3 into a plurality of blocks and upload the plurality of blocks to server 3 or may collectively upload the data to server 3. In a case where on-board unit 1 divides data D1 into a plurality of blocks and uploads the plurality of blocks to server 3, the data of the divided blocks may include common identification information or may include identification information for each divided block (the data sizes of the divided blocks). The sequences in FIGS. 7A and 7B indicate an example in which data D1 is divided into a plurality of blocks and the plurality of blocks is uploaded.

On-board unit 1 transfers (uploads) the first block of the data to roadside unit 2 in accordance with the reception of the upload approval transmitted in S44 (S45). For example, on-board unit 1 uploads the first block of the data by using HTTP communication.

Note that, S45 through S48 indicate an example of the uploading of the first block in a case where communication disconnection does not occur on the radio communication path between on-board unit 1 and roadside unit 2. Further, S45 through S48 indicate an example of the uploading of the first block in a case where communication disconnection does not occur in the communication line between roadside unit 2 and server 3.

Roadside unit 2 transfers the first block of the data transferred in S45 to server 3 (S46).

On-board unit 1 completes the data transfer to roadside unit 2 (S47).

Server 3 transmits a data transfer completion response to roadside unit 2 in a case where the data size of the received first block of the data matches the data size described in the HTTP header (the data size of the first block) (S48). The data transfer completion response may conform to, for example, HTTP Status Code 200.

Roadside unit 2 transfers the data transfer completion response in S48 to on-board unit 1 (S49).

Note that, the communication speed of the communication line is slower than the communication speed of the radio communication path. Accordingly, the time until the data transfer is completed in the communication line is longer than the time until the data transfer is completed on the radio communication path (see the time from S45 through S47 and the time from S46 through S48).

On-board unit 1 transfers (uploads) the second block of the data as the next block (S50). For example, on-board unit 1 transfers the second block of the data by using HTTP communication.

Roadside unit 2 transfers the second block of the data uploaded in S50 to server 3 (S51).

On-board unit 1 completes the data transfer to roadside unit 2 (S52).

Here, the radio communication on the radio communication path is disconnected. For example, in a case where on-board unit 1 moves outside the communication area of roadside unit 2, radio communication disconnection occurs. Alternatively, radio communication disconnection occurs due to the influence of disturbance.

In a case where on-board unit 1 connects with roadside unit 2 by radio communication again after the radio communication has been disconnected, on-board unit 1 transmits an upload resume request to roadside unit 2 (S53). The upload resume request includes identification information assigned by server 3.

In a case where roadside unit 2 receives the upload resume request in S53, roadside unit 2 determines, based on the identification information included in the upload resume request, the transfer status of the corresponding data to server 3. Here, the data corresponding to the identification information is the second block which is in the middle of being transferred, and roadside unit 2 determines that the data is being transferred.

In a case where roadside unit 2 receives the upload resume request in S53 and the data is being transferred to server 3, roadside unit 2 suspends the transfer of the upload resume request in S53 to server 3. For example, as indicated by the bidirectional dotted arrow illustrated in dotted frame S25 of FIG. 7B, roadside unit 2 suspends the transfer of the upload resume request to server 3 for a predetermined duration.

Note that, in a case where roadside unit 2 receives an upload resume request from on-board unit 1 again while the transfer of the upload resume request to server 3 is suspended, roadside unit 2 may transmit a message in conformity with HTTP Status Code 102 to on-board unit 1.

Alternatively, the timeout time for on-board unit 1 to transmit an upload resume request may be configured to be longer than a certain time. For example, the timeout time for on-board unit 1 may be configured to be longer than a time configured as the standard.

In a case where the data transfer of the second block by roadside unit 2 is completed, server 3 transmits a data transfer completion response to roadside unit 2 (S54). For example, in a case where the data size of the second block of the data received from roadside unit 2 matches the data size described in the HTTP header of the data transfer, server 3 transmits a data transfer completion response to roadside unit 2. The data transfer completion response may conform to, for example, HTTP Status Code 200.

Roadside unit 2 transfers the data transfer completion response in S55 to on-board unit 1 (S55).

After roadside unit 2 transfers every data (the first block and the second block) received from on-board unit 1 (after roadside unit 2 completes the transfer thereof), roadside unit 2 transfers the suspended upload resume request to server 3 (S56). The upload resume request includes the identification information on data D1 assigned by server 3.

In a case where server 3 receives the upload resume request in S56, server 3 acquires a reception total data size of data D1 corresponding to the identification information. The reception total data size refers to a reception total size of data managed by server 3 for each identification information and received from roadside unit 2.

Server 3 compares the acquired reception total data size of data D1 with the UL data size of data D1. In a case where the reception total data size of data D1 matches the UL data size of data D1, server 3 transmits an upload completion response for data D1 to roadside unit 2 (S57). The upload completion response may conform to, for example, HTTP Status Code 200.

Roadside unit 2 transfers the upload completion response in S57 to on-board unit 1 (S58).

With the processing described above, the uploading from on-board unit 1 to server 3 (uploading of data D1) is completed.

Subsequently, on-board unit 1 includes data (next data D2) to be uploaded to server 3.

On-board unit 1 transmits an upload request for data D2 to roadside unit 2 (S59).

Roadside unit 2 transfers the upload request for data D2 in S59 to server 3 (S60).

Server 3 transmits an upload approval for data D2 to roadside unit 2 in accordance with the reception of the upload request for data D2 in S60 (S61).

Roadside unit 2 transfers the upload approval for data D2 in S61 to on-board unit 1 (S62).

On-board unit 1 transfers data D2 to roadside unit 2 in accordance with the reception of the upload approval for data D2 transmitted in S62 (S63).

Note that, on-board unit 1 may divide the data (data D2) to be uploaded to server 3 into a plurality of blocks and upload the plurality of blocks to server 3 or may collectively upload the data to server 3.

Roadside unit 2 transfers data D2 transferred in S63 to server 3 (S64).

As described above, communication apparatus 21a of roadside unit 2 receives data transmitted from on-board unit 1, and communication apparatus 21b of roadside unit 2 transfers the data to server 3. CPU 22 of roadside unit 2 suspends, in a case where an upload resume request for the data has been received from on-board unit 1 while the data is being transferred to server 3, transfer of the upload resume request to server 3. Thus, on-board unit 1 can perform data uploading appropriately.

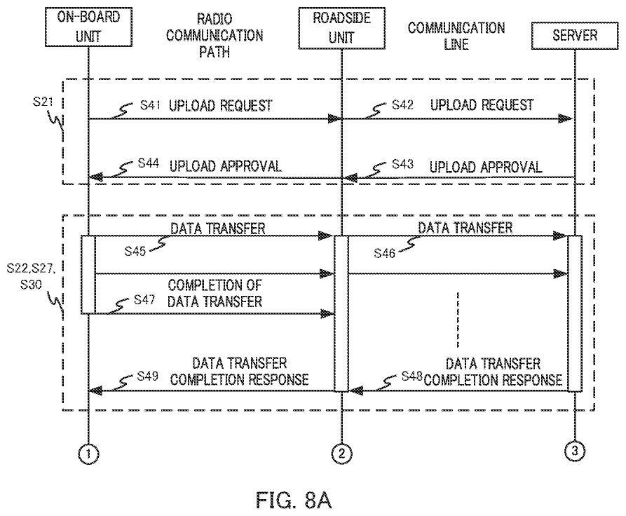

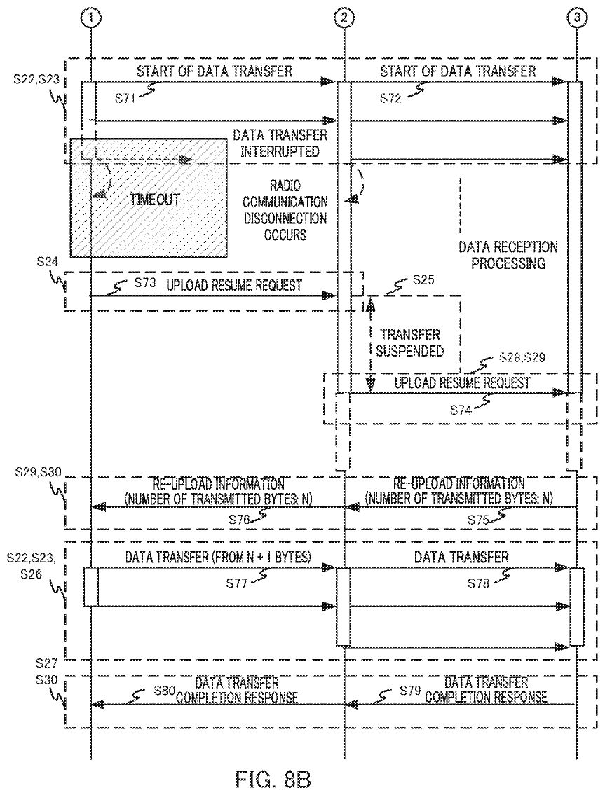

FIGS. 8A and 8B are sequence diagrams illustrating an operation example of the communication system of FIG. 1. The sequence illustrated in FIG. 8A is followed by the sequence of FIG. 8B. The reference signs for the dotted frames illustrated in FIGS. 8A and 8B correspond to the operations of the reference signs illustrated in FIG. 6. For example, dotted frame S21 illustrated in FIGS. 8A and 8B corresponds to the operation in S21 illustrated in FIG. 6.

The sequences illustrated in FIGS. 8A and 8B indicate an operation example in a case where radio communication disconnection between on-board unit 1 and roadside unit 2 occurs before data uploading from on-board unit 1 to roadside unit 2 is completed (during data transfer) (see the hatched part in FIG. 8B). Further, the sequences illustrated in FIGS. 8A and 8B indicate an operation example in a case where roadside unit 2 is performing data transfer to server 3 when roadside unit 2 receives an upload resume request from on-board unit 1 (see S53 in FIG. 8B).

The processing of S41 to S49 illustrated in FIG. 8A is the same as the processing in S41 to S49 illustrated in FIG. 7A, and a description thereof will be omitted.

As illustrated in FIG. 8B, on-board unit 1 transfers a second block of data D1 as the next block (S71). For example, on-board unit 1 transfers the data by using HTTP communication.

Roadside unit 2 transfers the second block of data D1 transferred in S71 to server 3 (S72).

Here, the radio communication on the radio communication path between on-board unit 1 and roadside unit 2 is disconnected before on-board unit 1 completes the uploading of the second block (during data transfer). For example, in a case where on-board unit 1 moves outside the communication area of roadside unit 2, radio communication disconnection occurs. Alternatively, radio communication disconnection occurs due to the influence of disturbance. The uploading of the second block of data D1 is interrupted by the radio communication disconnection.

In a case where the radio communication is disconnected and on-board unit 1 then connects with roadside unit 2 by radio communication again, on-board unit 1 transmits an upload resume request for the second block to roadside unit 2 (S73). The upload resume request includes identification information assigned by server 3.

In a case where roadside unit 2 receives the upload resume request in S73, roadside unit 2 determines, based on the identification information, the transfer status of the corresponding second block of data D1 to server 3. Here, the second block of data D1 corresponding to the identification information is in the middle of being transferred, and roadside unit 2 determines that the data is being transferred.

In a case where on-board unit 1 interrupts the uploading of the second block of data D1 and roadside unit 2 receives the upload resume request from on-board unit 1, roadside unit 2 suspends the transfer of the upload resume request in S73 to server 3 when the data transfer of the second block of data D1 to server 3 is under way. For example, as indicated by the bidirectional dotted arrow illustrated in dotted frame S25 of FIG. 8B, roadside unit 2 suspends the transfer of the upload resume request to server 3.

Roadside unit 2 transfers all the second block of data D1 received from on-board unit 1 (the data received from on-board unit 1 before the radio communication disconnection) to server 3 and then transmits the upload resume request to server 3 (S74). The upload resume request includes identification information on the second block of data D1 assigned by server 3.

Note that, in a case where roadside unit 2 receives an upload resume request from on-board unit 1 again while the transfer of the upload resume request to server 3 is suspended, roadside unit 2 may transmit a message in conformity with HTTP Status Code 102 to on-board unit 1.

Alternatively, the timeout time for on-board unit 1 to transmit an upload resume request may be configured to be longer than a certain time. For example, the timeout time for on-board unit 1 may be configured to be longer than a time configured as the standard.

In a case where server 3 receives the upload resume request in S74, server 3 acquires the reception total data size of the second-block of data D1 corresponding to the identification information.

Server 3 compares the acquired reception total data size of the second block of data D1 with the UL data size of the second block of data D1. Since on-board unit 1 interrupts the uploading of the second block of data D1 in the middle of the uploading, server 3 determines that the reception total data size of the second block of data D1 is fewer than the UL data size of the second block of data D1, and transmits re-upload information to roadside unit 2 (S75). The re-upload information includes information on the reception total data size of the second block of data D1. The “NUMBER OF TRANSMITTED BYTES: N” illustrated in S75 of FIG. 8B indicates the reception total data size of the second block of data D1 included in the re-upload information. The re-upload information may conform to, for example, HTTP Status Code 100.

Roadside unit 2 transfers the re-upload information in S75 to on-board unit 1 (S76).

On-board unit 1 resumes the data transfer in accordance with the reception of the re-upload information in S76 (S77). On-board unit 1 resumes the data transfer of the second block of data D1 from data of the N+1-th byte based on the information on the reception total data size included in the re-upload information.

Roadside unit 2 transfers the data transferred in S77 to server 3 (S78).

In a case where the uploading by roadside unit 2 is completed, server 3 transmits a data transfer completion response to roadside unit 2 (S79).

Roadside unit 2 transfers the data transfer completion response in S79 to on-board unit 1 (S80). Note that, upload completion responses S57 and S58 may be omitted in FIG. 8B.

As described above, CPU 22 of roadside unit 2 receives re-upload information including information indicative of an uploaded data volume from server 3, and transfers the re-upload information to on-board unit 1. Thus, on-board unit 1 can resume the uploading from data having not been uploaded to server 3 and can perform data uploading appropriately.

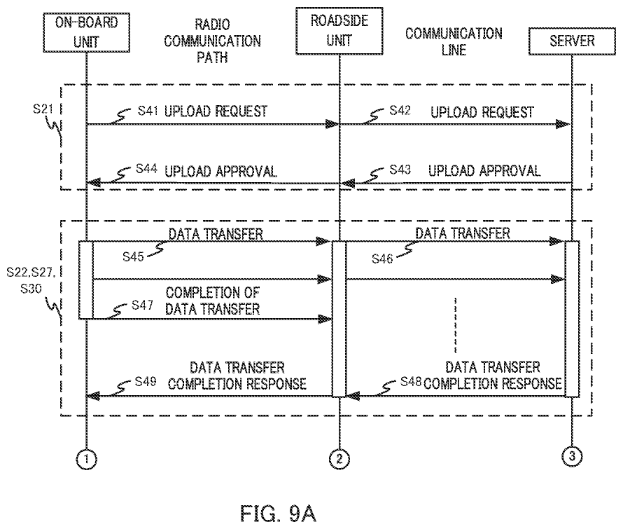

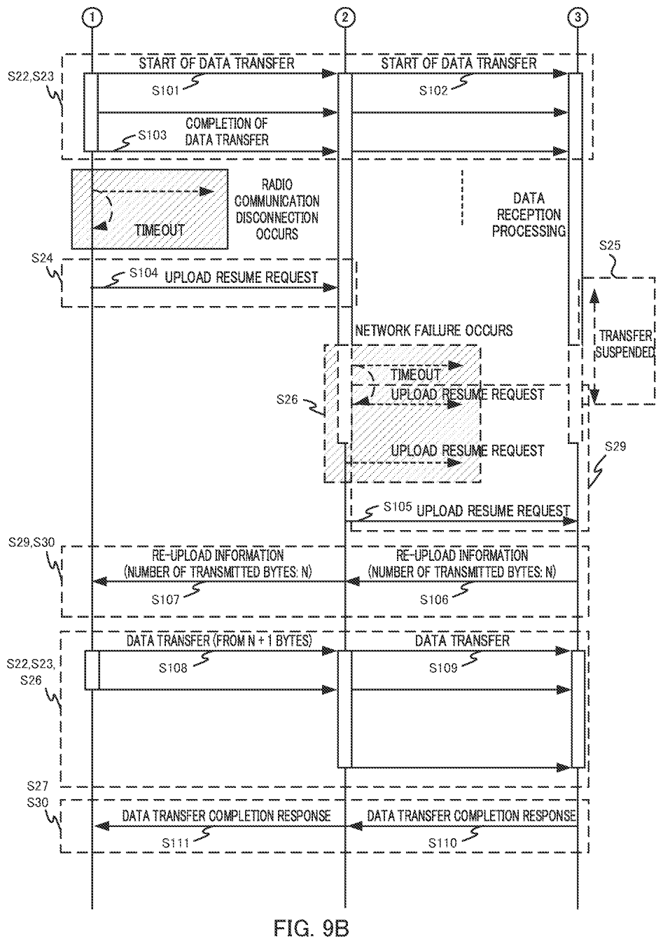

FIGS. 9A and 9B are sequence diagrams illustrating an operation example of the communication system of FIG. 1. The sequence illustrated in FIG. 9A is followed by the sequence of FIG. 9B. The reference signs for the dotted frames illustrated in FIGS. 9A and 9B correspond to the operations of the reference signs illustrated in FIG. 6. For example, dotted frame S21 illustrated in FIGS. 9A and 9B corresponds to the operation in S21 illustrated in FIG. 6.

The sequences illustrated in FIGS. 9A and 9B indicate an operation example in a case where radio communication disconnection between on-board unit 1 and roadside unit 2 occurs after the data transfer from on-board unit 1 to roadside unit 2 is completed (see the hatched part on the upper side in FIG. 9B). Further, the sequences illustrated in FIGS. 9A and 9B indicate an operation example in a case where roadside unit 2 receives an upload resume request from on-board unit 1 and the communication line between roadside unit 2 and server 3 is then disconnected while roadside unit 2 is performing data transfer to server 3 (see hatched part S26 on the lower side of FIG. 9B).

The processing of S41 to S49 illustrated in FIG. 9A is the same as the processing in S41 to S49 illustrated in FIG. 7A, and a description thereof will be omitted.

As illustrated in FIG. 9B, on-board unit 1 transfers (uploads) a second block of data D1 as the next block (S101). For example, on-board unit 1 transfers the data by using HTTP communication.

Roadside unit 2 transfers the second block of data D1 uploaded in S101 to server 3 (S102).

On-board unit 1 completes the data transfer to roadside unit 2 (S103).

Here, the radio communication on the radio communication path between on-board unit 1 and roadside unit 2 is disconnected. For example, in a case where on-board unit 1 moves outside the communication area of roadside unit 2, radio communication disconnection occurs. Alternatively, radio communication disconnection between on-board unit 1 and roadside unit 2 occurs due to the influence of disturbance.

In a case where on-board unit 1 connects with roadside unit 2 by radio communication again after the radio communication has been disconnected, on-board unit 1 transmits an upload resume request to roadside unit 2 (S104). The upload resume request includes identification information assigned by server 3.

In a case where roadside unit 2 receives the upload resume request in S104, roadside unit 2 determines, based on the identification information, the transfer status of the corresponding data to server 3. Here, the data corresponding to the identification information is in the middle of being transferred, and roadside unit 2 determines that the data is being transferred.

In a case where the data transfer to server 3 is under way after on-board unit 1 completes the data transfer in S103, roadside unit 2 suspends the transfer of the upload resume request in S103 to server 3. For example, as indicated by the bidirectional dotted arrow illustrated in dotted frame S25 of FIG. 9B, roadside unit 2 suspends the transfer of the upload resume request to server 3.

Here, the communication line between roadside unit 2 and server 3 is disconnected, while roadside unit 2 suspends the transfer of the upload resume request to server 3 and before roadside unit 2 completes the uploading of the data in on-board unit 1 (S26).

While the communication line between roadside unit 2 and server 3 is disconnected, roadside unit 2 times out the transfer suspension processing of the upload resume request and stops the transfer suspension processing of the upload resume request. Roadside unit 2 transfers the upload resume request to server 3 by stopping the transfer suspension processing (see hatched part S26 on the lower side of FIG. 9B). In a case where the transmission of the upload resume request fails, roadside unit 2 may repeatedly transfer the upload resume request at regular intervals.

In a case where the communication line is restored, roadside unit 2 transfers the upload resume request to server 3 (S105). The upload resume request includes identification information assigned by server 3.

In a case where server 3 receives the upload resume request in S105, server 3 acquires the reception total data size of data D1 corresponding to identification information.

Server 3 compares the acquired reception total data size of data D1 with the UL data size. Since the uploading of data D1 from roadside unit 2 is interrupted in the middle of the uploading due to the communication line disconnection, server 3 determines that the reception total data size of data D1 is fewer than the UL data size, and transmits re-upload information to roadside unit 2 (S106). The re-upload information includes information on the reception total data size of data D1. The “NUMBER OF TRANSMITTED BYTES: N” illustrated in S106 of FIG. 9B indicates the reception total data size of data D1 included in the re-upload information. The re-upload information may conform to, for example, HTTP Status Code 100.

Roadside unit 2 transfers the re-upload information in S106 to on-board unit 1 (S107).

On-board unit 1 resumes the data transfer in accordance with the reception of the re-upload information in S107 (S108). On-board unit 1 resumes the data transfer from data of N+1 bytes based on the information on the reception total data size included in the re-upload information.

Roadside unit 2 transfers the data transferred in S108 to server 3 (S109).

In a case where the uploading by roadside unit 2 is completed, server 3 transmits a data transfer completion response to roadside unit 2 (S110).

Roadside unit 2 transfers the data transfer completion response in S110 to on-board unit 1 (S111). Note that, upload completion responses S57 and S58 may be omitted in FIG. 9B.

As described above, in a case where the communication with server 3 is disconnected and the transfer suspension processing of the upload resume request by on-board unit 1 is timed out, CPU 22 of roadside unit 2 transfers the upload resume request by on-board unit 1 to server 3. Thus, server 3 can transmit re-upload information to on-board unit 1, and on-board unit 1 can perform data uploading appropriately.

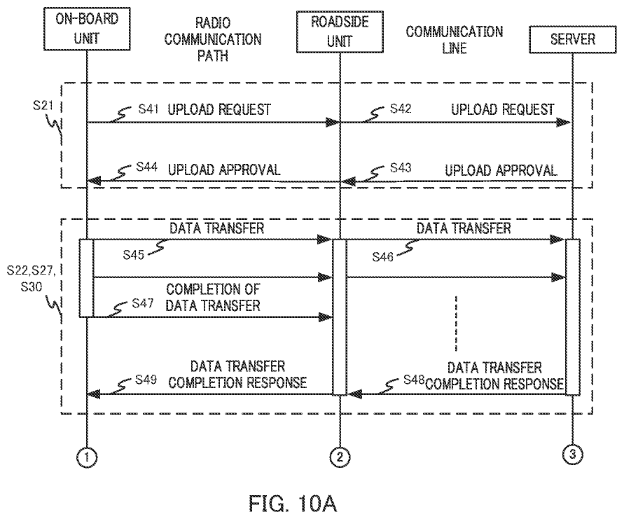

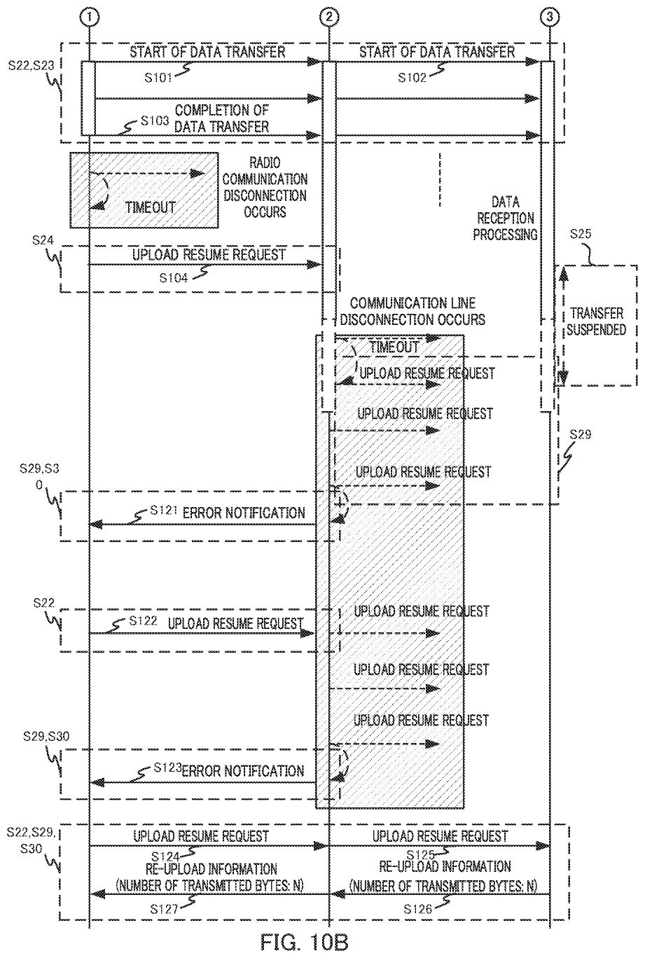

FIGS. 10A and 10B are sequence diagrams illustrating an operation example of the communication system of FIG. 1. The sequence illustrated in FIG. 10A is followed by the sequence of FIG. 10B. The reference signs for the dotted frames illustrated in FIGS. 10A and 10B correspond to the operations of the reference signs illustrated in FIG. 6. For example, dotted frame S21 illustrated in FIGS. 10A and 10B corresponds to the operation in S21 illustrated in FIG. 6.

The sequences illustrated in FIGS. 10A and 10B indicate, with respect to the sequences illustrated in FIGS. 9A and 9B, an operation example in a case where disconnection occurs in the communication line between roadside unit 2 and server 3 and the communication line is then not restored even when roadside unit 2 transmits the upload resume request a predetermined number of times (see the hatched part on the lower side of FIG. 10B).

The processing of S41 to S49 illustrated in FIG. 10A is the same as the processing in S41 to S49 illustrated in FIG. 7A, and a description thereof will be omitted. The processing in S101 to S104 illustrated in FIG. 10B is the same as the processing in S101 to S104 illustrated in FIG. 9B, and a description thereof will be omitted.

Here, the communication line between roadside unit 2 and server 3 is disconnected, while roadside unit 2 suspends the transfer of the upload resume request to server 3 and before roadside unit 2 completes the uploading of the data in on-board unit 1.

While the communication line between roadside unit 2 and server 3 is disconnected, roadside unit 2 times out the transfer suspension processing of the upload resume request and stops the transfer suspension processing of the upload resume request. Roadside unit 2 transfers the upload resume request to server 3 by stopping the transfer suspension processing (see the hatched part on the lower side of FIG. 10B). In a case where the transmission of the upload resume request fails, roadside unit 2 repeatedly transmits the upload resume request at regular intervals.

In a case where roadside unit 2 transfers the upload resume request a predetermined number of times (three times in the example of FIG. 10B) to server 3, but does not receive a response from server 3, roadside unit 2 transmits an error notification to on-board unit 1 (S121). The error notification may conform to, for example, HTTP Status Codes 5xx.

On-board unit 1 transmits an upload resume request to roadside unit 2 in accordance with the reception of the error notification in S121 (S122). The upload resume request includes identification information on data D1 assigned by server 3.

Roadside unit 2 transfers the upload resume request for data D1 to server 3 in accordance with the reception of the upload resume request in S122.

Here, the communication line disconnection between roadside unit 2 and server 3 continues. The transfer of the upload resume request by roadside unit 2 fails and roadside unit 2 repeatedly transfers the upload resume request at regular intervals.

In a case where roadside unit 2 transfers the upload resume request a predetermined number of times (three times in the example of FIG. 10B) to server 3, but does not receive a response from server 3, roadside unit 2 transmits an error notification to on-board unit 1 (S123).

On-board unit 1 transmits an upload resume request to roadside unit 2 in accordance with the reception of the error notification in S123 (S124).

Here, the communication line between roadside unit 2 and server 3 is restored. Roadside unit 2 transfers the upload resume request in S124 to server 3 (S125). The transfer of the upload resume request by roadside unit 2 is successful.

In a case where server 3 receives the upload resume request in S125, server 3 acquires the reception total data size of the data corresponding to the identification information.

Server 3 compares the acquired reception total data size of data D1 with the UL data size. Since the uploading of data D1 from roadside unit 2 is interrupted in the middle of the uploading due to the communication line disconnection, server 3 determines that the reception total data size of data D1 is fewer than the UL data size, and transmits re-upload information to roadside unit 2 (S126). The re-upload information includes information on the reception total data size of data D1. The “NUMBER OF TRANSMITTED BYTES: N” illustrated in S126 of FIG. 10B indicates the reception total data size of data D1 included in the re-upload information. The re-upload information may conform to, for example, HTTP Status Code 100.

Roadside unit 2 transfers the re-upload information in S126 to on-board unit 1 (S127).

Note that, on-board unit 1 resumes the data transfer in accordance with the reception of the re-upload information in S127. On-board unit 1 resumes the data transfer from data of N+1 bytes based on the information on the reception total data size included in the re-upload information. Note that, upload completion responses S57 and S58 may be omitted in FIG. 10B.

As described above, in a case where CPU 22 of roadside unit 2 suspends the transfer of an upload resume request, then starts the transfer of the upload resume request, but the upload resume request is not received by server 3, CPU 22 transmits an error notification to on-board unit 1. Thus, on-board unit 1 can transmit the upload resume request to roadside unit 2 again and can perform data uploading appropriately.

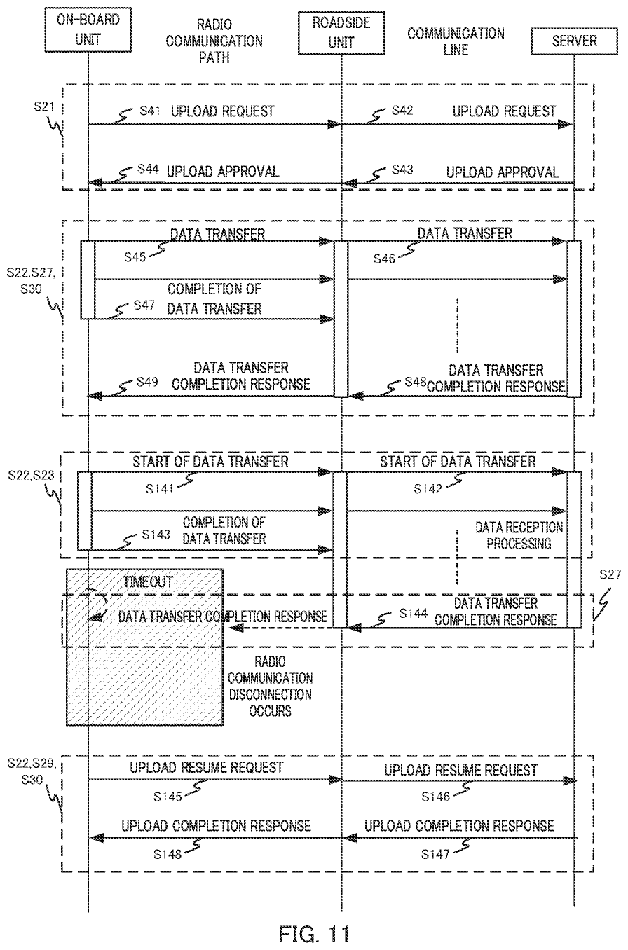

FIG. 11 is a sequence diagram illustrating an operation example of the communication system of FIG. 1. The reference signs for the dotted frames illustrated in FIG. 11 correspond to the operations of the reference signs illustrated in FIG. 6. For example, dotted frame S21 illustrated in FIG. 11 corresponds to the operation in S21 illustrated in FIG. 6.

The sequence illustrated in FIG. 11 indicates an operation example in a case where the uploading of data of a second block of data D1 from on-board unit 1 to roadside unit 2 is completed and radio communication disconnection then occurs on the radio communication path between on-board unit 1 and roadside unit 2 (see the hatched part in FIG. 11). Further, the sequence illustrated in FIG. 11 indicates an operation example in a case where radio communication disconnection occurs on the radio communication path between on-board unit 1 and roadside unit 2 when roadside unit 2 receives a data transfer completion response for the second-block of data D1 from server 3 (see the hatched part in FIG. 11).

The processing of S41 to S49 illustrated in FIG. 11 is the same as the processing in S41 to S49 illustrated in FIG. 7A, and a description thereof will be omitted.

As illustrated in FIG. 11, on-board unit 1 transfers the second block of data D1 as the next block (S141). For example, on-board unit 1 transfers the data by using HTTP communication.

Roadside unit 2 transfers the second block of data D1 transferred in S141 to server 3 (S142).

On-board unit 1 completes the data transfer to roadside unit 2 (S143).

Here, the radio communication on the radio communication path between on-board unit 1 and roadside unit 2 is disconnected. For example, in a case where on-board unit 1 moves outside the communication area of roadside unit 2, radio communication disconnection occurs. Alternatively, radio communication disconnection between on-board unit 1 and roadside unit 2 occurs due to the influence of disturbance. Note that, roadside unit 2 continues transferring the second block of data D1 received from on-board unit 1 to server 3.

In a case where the data transfer by roadside unit 2 is completed, server 3 transmits a data transfer completion response to roadside unit 2 (S144). For example, in a case where the data size of data D1 received from roadside unit 2 matches the data size described in the HTTP header of the data transfer, server 3 transmits a data transfer completion response to roadside unit 2. The data transfer completion response may conform to, for example, HTTP Status Code 200.

Here, since the radio communication between on-board unit 1 and roadside unit 2 is disconnected, roadside unit 2 transfers the data transfer completion response in S144 to on-board unit 1, but the transfer fails due to the radio communication disconnection.

In a case where the radio communication between on-board unit 1 and roadside unit 2 is restored and on-board unit 1 does not receive a data transfer completion response from server 3, on-board unit 1 transmits an upload resume request to roadside unit 2 (S145).

Roadside unit 2 transfers the upload resume request in S145 to server 3 (S146). Since roadside unit 2 has completed the data transfer of the second block of data D1, roadside unit 2 transfers the upload resume request to server 3 without suspending the upload resume request.

In a case where server 3 receives the upload resume request in S146, server 3 acquires the reception total data size of data D1 corresponding to the identification information.

Server 3 compares the acquired reception total data size of data D1 with the UL data size. In a case where the reception total data size of data D1 matches the UL data size, server 3 transmits an upload completion response to roadside unit 2 (S147). The upload completion response may conform to, for example, HTTP Status Code 200.

Roadside unit 2 transmits the upload completion response to on-board unit 1 in accordance with the reception of the upload completion response in S147 (S148).

As described above, in a case where data transfer is completed, the radio communication with roadside unit 2 is then disconnected, and CPU 11 of on-board unit 1 does not receive a data transfer completion response from server 3, CPU 11 transmits an upload resume request to server 3 after the communication with roadside unit 2 is restored. Thus, on-board unit 1 can upload data D1 appropriately.

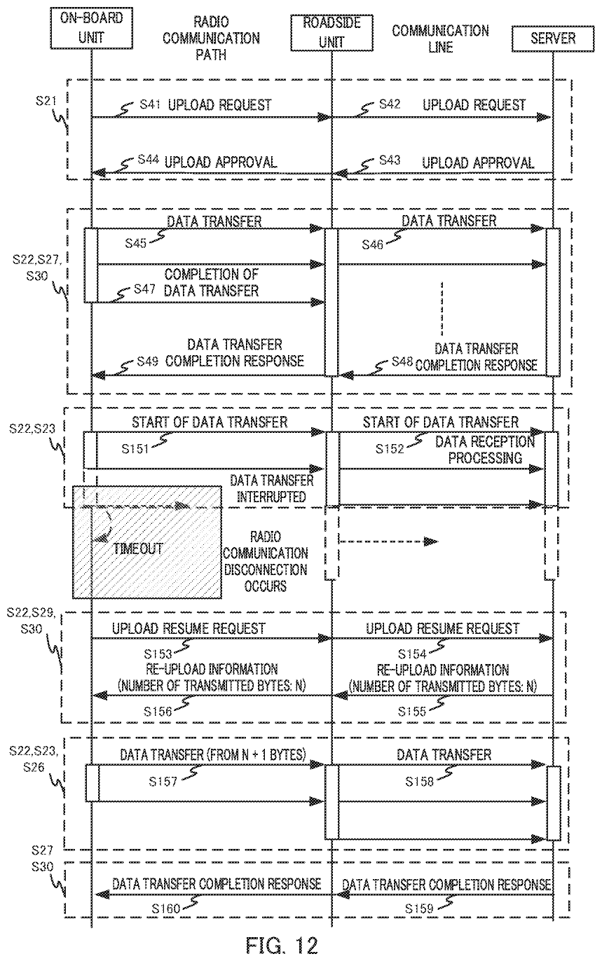

FIG. 12 is a sequence diagram illustrating an operation example of the communication system of FIG. 1. The reference signs for the dotted frames illustrated in FIG. 12 correspond to the operations of the reference signs illustrated in FIG. 6. For example, dotted frame S21 illustrated in FIG. 12 corresponds to the operation in S21 illustrated in FIG. 6.

The sequence illustrated in FIG. 12 indicates an operation example in a case where radio communication disconnection occurs on the radio communication path between on-board unit 1 and roadside unit 2 before the data transfer from on-board unit 1 to roadside unit 2 is completed (during data transfer) (see the hatched part in FIG. 12). Further, the sequence illustrated in FIG. 12 indicates an operation example in a case where the data transfer from on-board unit 1 to server 3 is interrupted due to the occurrence of radio communication disconnection on the radio communication path between on-board unit 1 and roadside unit 2 before the data transfer from on-board unit 1 to roadside unit 2 is completed (see the hatched part in FIG. 12).

The processing of S41 to S49 illustrated in FIG. 12 is the same as the processing in S41 to S49 illustrated in FIG. 7A, and a description thereof will be omitted.

As illustrated in FIG. 12, on-board unit 1 transfers data of the next block (S151). For example, on-board unit 1 transfers the data by using HTTP communication.

Roadside unit 2 transfers the data transferred in S151 to server 3 (S152).

Here, the radio communication on the radio communication path between on-board unit 1 and roadside unit 2 is disconnected before the data transfer of the next block is completed (during data transfer). For example, in a case where on-board unit 1 moves outside the communication area of roadside unit 2, radio communication disconnection between on-board unit 1 and roadside unit 2 occurs. Alternatively, radio communication disconnection between on-board unit 1 and roadside unit 2 occurs due to the influence of disturbance.

The uploading (data transfer) of the second block of data D1 by on-board unit 1 is interrupted due to the radio communication disconnection. Roadside unit 2 transfers data received from on-board unit 1 to server 3 until the radio communication between on-board unit 1 and roadside unit 2 is restored.

In a case where on-board unit 1 connects with roadside unit 2 by radio communication again after the radio communication has been disconnected, on-board unit 1 transmits an upload resume request to roadside unit 2 (S153). The upload resume request includes identification information assigned by server 3.

Roadside unit 2 transfers the upload resume request in S153 to server 3 (S154). The upload resume request includes identification information on data D1 assigned by server 3.

Note that, when roadside unit 2 receives the upload resume request from on-board unit 1, roadside unit 2 does not suspend the transfer of the upload resume request to server 3 in a case where all the data received from on-board 1 (the second block of data D1 received before the radio communication on the radio communication path is disconnected) is transferred to server 3.

In a case where server 3 receives the upload resume request in S154, server 3 acquires the reception total data size of data D1 corresponding to the identification information.

Server 3 compares the acquired reception total data size of data D1 with the UL data size. Since on-board unit 1 interrupts the uploading of the second block of data D1 in the middle of the uploading by the disconnection of the radio communication on the radio communication path, server 3 determines that the reception total data size of data D1 is fewer than the UL data size, and transmits re-upload information to roadside unit 2 (S155). The re-upload information includes information on the reception total data size of data D1. The “NUMBER OF TRANSMITTED BYTES: N” illustrated in S155 of FIG. 12 indicates the reception total data size of data D1 included in the re-upload information. The re-upload information may conform to, for example, HTTP Status Code 100.

Roadside unit 2 transfers the re-upload information in S155 to on-board unit 1 (S156).

On-board unit 1 resumes the data transfer in accordance with the reception of the re-upload information in S156 (S157). On-board unit 1 resumes the data transfer from data of N+1 bytes based on the information on the reception total data size included in the re-upload information.

Roadside unit 2 transfers the data transferred in S157 to server 3 (S158).

In a case where the uploading by roadside unit 2 is completed, server 3 transmits a data transfer completion response to roadside unit 2 (S159).

Roadside unit 2 transfers the data transfer completion response in S159 to on-board unit 1 (S160). Note that, upload completion responses S57 and S58 may be omitted in FIG. 12.

As described above, in a case where the radio communication with roadside unit 2 is disconnected before data transfer is completed, and CPU 11 of on-board unit 1 does not receive re-upload information from server 3, CPU 11 transmits an upload resume request to server 3 after the radio communication with roadside unit 2 is restored. CPU 31 of server 3 transmits re-upload information to on-board unit 1 in accordance with the upload resume request from on-board unit 1. Thus, on-board unit 1 can perform data uploading appropriately.

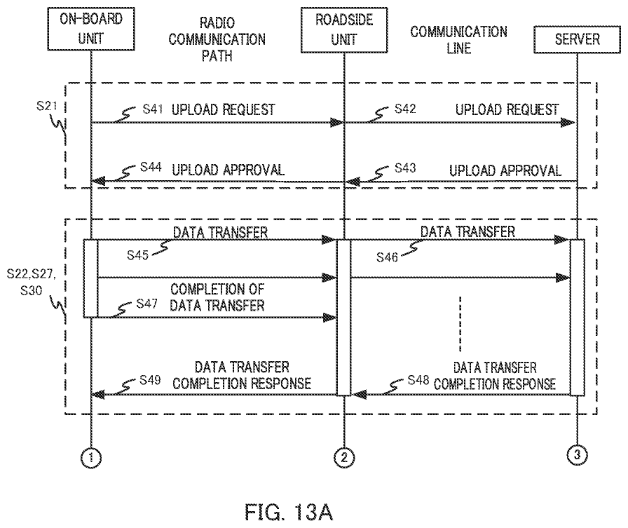

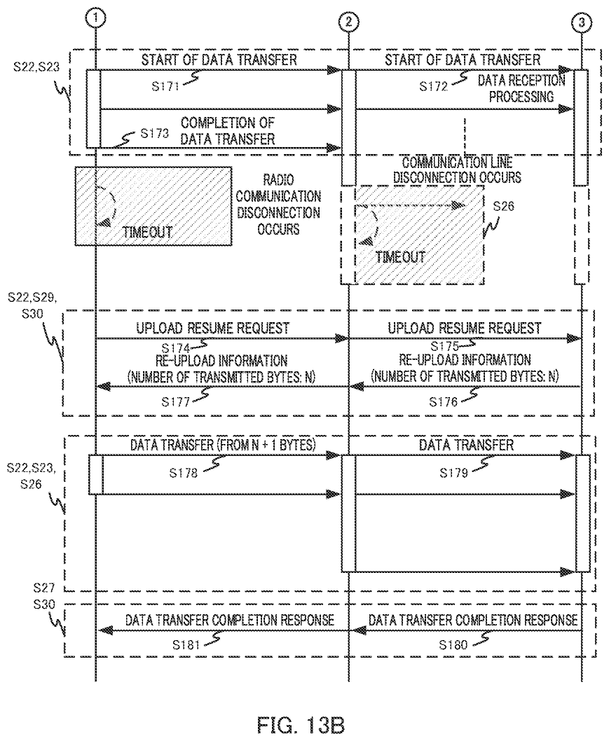

FIGS. 13A and 13B are sequence diagram illustrating an operation example of the communication system of FIG. 1. The sequence illustrated in FIG. 13A is followed by the sequence of FIG. 13B. The reference signs for the dotted frames illustrated in FIGS. 13A and 13B correspond to the operations of the reference signs illustrated in FIG. 6. For example, dotted frame S21 illustrated in FIGS. 13A and 13B corresponds to the operation in S21 illustrated in FIG. 6.

The sequences illustrated in FIGS. 13A and 13B indicate an operation example in a case where radio communication disconnection between on-board unit 1 and roadside unit 2 occurs after the data transfer from on-board unit 1 to roadside unit 2 is completed (see the hatched part on the left side in FIG. 13B). Further, the sequences illustrated in FIGS. 13A and 13B indicate an operation example in a case where communication disconnection occurs in the communication line between roadside unit 2 and server 3 before the data transfer from roadside unit 2 to server 3 is completed (see hatched part S26 on the right side of FIG. 13). Further, the sequences in FIGS. 13A and 13B indicate an operation example in a case where on-board unit 1 transmits an upload resume request after the radio communication between on-board unit 1 and roadside unit 2 and the communication between roadside unit 2 and server 3 are restored.

The processing of S41 to S49 illustrated in FIG. 13A is the same as the processing in S41 to S49 illustrated in FIG. 7A, and a description thereof will be omitted.

As illustrated in FIG. 13B, on-board unit 1 transfers a second block of data D1 as the next block (S171). For example, on-board unit 1 transfers the data by using HTTP communication.

Roadside unit 2 transfers the second block of data D1 transferred in S171 to server 3 (S172).

On-board unit 1 completes the data transfer to roadside unit 2 (S173).

Here, the radio communication on the radio communication path between on-board unit 1 and roadside unit 2 is disconnected. For example, in a case where on-board unit 1 moves outside the communication area of roadside unit 2, radio communication disconnection occurs. Alternatively, radio communication disconnection between on-board unit 1 and roadside unit 2 occurs due to the influence of disturbance.

Further, while roadside unit 2 is transferring the data in on-board unit 1 to server 3, disconnection in the communication line between roadside unit 2 and server 3 occurs. Roadside unit 2 times out before completing the transfer of the data in on-board unit 1. That is, roadside unit 2 interrupts the transfer of the data in on-board unit 1 in the middle of the data transfer.

In a case where on-board unit 1 connects with roadside unit 2 by radio communication again after the radio communication has been disconnected, on-board unit 1 transmits an upload resume request to roadside unit 2 (S174). The upload resume request includes identification information on data D1 assigned by server 3.

Roadside unit 2 transmits an upload resume request to server 3 in accordance with the reception of the upload resume request in S174 (S175). The upload resume request includes the identification information on data D1 assigned by server 3.

Note that, since roadside unit 2 ends (times out) the transfer processing of the data in on-board unit 1 to server 3 when roadside unit 2 receives the upload resume request in S175, roadside unit 2 may not suspend the transfer of the upload resume request to server 3.

In a case where server 3 receives the upload resume request in S175, server 3 acquires the reception total data size of data D1 corresponding to the identification information.

Server 3 compares the acquired reception total data size of data D1 with the UL data size. Since roadside unit 2 interrupts the uploading of data D1 in the middle of the uploading by the communication disconnection between roadside unit 2 and server 3, server 3 determines that the reception total data size of data D1 is fewer than the UL data size, and transmits re-upload information to roadside unit 2 (S176). The re-upload information includes information on the reception total data size of data D1. The “NUMBER OF TRANSMITTED BYTES: N” illustrated in S176 of FIG. 13B indicates the reception total data size included in the re-upload information. The re-upload information may conform to, for example, HTTP Status Code 100.

Roadside unit 2 transfers the re-upload information in S176 to on-board unit 1 (S177).

On-board unit 1 resumes the data transfer in accordance with the reception of the re-upload information in S177 (S178). On-board unit 1 resumes the data transfer from data of N+1 bytes based on the information on the reception total data size of data D1 included in the re-upload information.

Roadside unit 2 transfers the second block of data D1 transferred in S178 to server 3 (S179).

In a case where the uploading by roadside unit 2 is completed, server 3 transmits a data transfer completion response to roadside unit 2 (S180).

Roadside unit 2 transfers the data transfer completion response in S180 to on-board unit 1 (S181). Note that, upload completion responses S57 and S58 may be omitted in FIG. 13B.

As described above, in a case where data transfer is completed, the radio communication with roadside unit 2 is then disconnected, and CPU 11 of on-board unit 1 does not receive a data transfer completion response from server 3, CPU 11 transmits an upload resume request to server 3 after the communication with roadside unit 2 is restored. In a case where the uploading by on-board unit 1 is not completed, CPU 33 of server 3 transmits re-upload information including information on a reception total data size to on-board unit 1. Thus, on-board unit 1 can perform data uploading appropriately.

(Variation 1)

In a case where CPU 22 of roadside unit 2 suspends the transfer of an upload resume request, CPU 22 may transmit information for controlling a transmission interval of the upload resume request transmitted by on-board unit 1 to on-board unit 1. For example, CPU 22 may cause the transmission interval of the upload resume request by on-board unit 1 after the suspension of the transfer of the upload resume request to be longer than the transmission interval before the suspension of the transfer. Thus, it is possible to suppress frequent transmission of the upload resume request by on-board unit 1 to roadside unit 2 while roadside unit 2 suspends the transfer of the upload resume request.

(Variation 2)

After the communication with roadside unit 2 is disconnected, CPU 21 of on-board unit 1 may configure the transmission interval of an upload resume request to be longer than the transmission interval before the communication with roadside unit 2 is disconnected. Thus, it is possible to suppress frequent transmission of the upload resume request by on-board unit 1 to roadside unit 2 while roadside unit 2 suspends the transfer of the upload resume request. Note that, in a case where the communication with roadside unit 2 is restored, CPU 21 may return the transmission interval of the upload resume request to the original transmission interval.

In the above-described embodiments, the expressions “section”, “-er”, “-or”, and “-ar” used for the component elements may be replaced with other expressions such as “circuitry”, “device”, “unit”, or “module”.

The description has been given of embodiments with reference to the accompanying drawings, but the present disclosure is not limited to the embodiments. It is apparent that variations or modifications in the category recited in the claims may be conceived of by a person skilled in the art. It is to be understood that such variations or modifications also fall within the technical scope of the present disclosure. In addition, the component elements in the embodiments may be optionally combined without departing from the spirit of the present disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

(Summary of the Present Disclosure)

A roadside unit according to the present disclosure includes: communication circuitry, which, in operation, receives data transmitted from an on-board unit and transfers the data to a server; and control circuitry, which, in operation, suspends, in a case where the communication circuitry has received an upload resume request for the data from the on-board unit while the data is being transferred to the server, transfer of the upload resume request to the server.

In the roadside unit according to the present disclosure, the control circuitry receives a data transfer completion response for the data from the server through the communication circuitry, and then transfers the upload resume request to the server.

In the roadside unit according to the present disclosure, the control circuitry receives re-upload information from the server through the communication circuitry, and transfers the re-upload information to the on-board unit, the re-upload information including information indicative of an uploaded data volume of the data.

In the roadside unit according to the present disclosure, in a case where communication with the server is disconnected and a timeout occurs, the control circuitry transfers the upload resume request to the server through the communication circuitry.

In the roadside unit according to the present disclosure, in a case where the control circuitry suspends the transfer of the upload resume request, then starts the transfer of the upload resume request, but the upload resume request is not received by the server, the control circuitry transmits an error notification to the on-board unit through the communication circuitry.

In the roadside unit according to the present disclosure, in a case where the control circuitry suspends the transfer of the upload resume request, the control circuitry transmits information to the on-board unit through the communication circuitry. The information is information for controlling a transmission interval of the upload resume request transmitted by the on-board unit.

An on-board unit according to the present disclosure includes: communication circuitry, which, in operation, performs communication with a roadside unit including: transfer circuitry, which, in operation, receives data and transfers the data to a server; and control circuitry, which, in operation, suspends, in a case where an upload resume request for the data has been received from the on-board unit while the data is being transferred to the server, transfer of the upload resume request to the server; and control circuitry, which, in operation, configures, after the communication with the roadside unit is disconnected, a transmission interval of the upload resume request to be longer than a transmission interval of the upload resume request before the communication with the roadside unit is disconnected.

A communication system according to the present disclosure includes: an on-board unit; and a roadside unit. The on-board unit includes: on-board unit communication circuitry, which, in operation, transmits data; and on-board unit control circuitry, which, in operation, transmits an upload resume request for the data. The roadside unit includes: roadside unit communication circuitry, which, in operation, receives the data and transfers the data to a server; and roadside unit control circuitry, which, in operation, suspends, in a case where the upload resume request for the data has been received while the data is being transferred to the server, transfer of the upload resume request to the server.

A communication method according to the present disclosure includes: receiving data transmitted from an on-board unit; transferring the data to a server; and suspending, in a case where an upload resume request for the data has been received from the on-board unit while the data is being transferred to the server, transfer of the upload resume request to the server.

The disclosure of Japanese Patent Application No. 2020-042246, filed on Mar. 11, 2020, including the specification, drawings and abstract, is incorporated herein by reference in its entirety.

### INDUSTRIAL APPLICABILITY

The present disclosure is useful for a communication system that uploads data in an on-board unit to a server.

### REFERENCE SIGNS LIST

1 On-board unit
2 Roadside unit
3 Server
4 Network
11, 21a, 21b, 31 Communication apparatus
12, 22, 32 CPU
13, 23, 33 Storage apparatus

1. A roadside unit, comprising:
communication circuitry, which, in operation, receives data transmitted from an on-board unit and transfers the data to a server; and
control circuitry, which, in operation, suspends, in a case where the communication circuitry has received an upload resume request for the data from the on-board unit while the data is being transferred to the server, transfer of the upload resume request to the server.

2. The roadside unit according to claim 1, wherein the control circuitry receives a data transfer completion response for the data from the server through the communication circuitry, and then transfers the upload resume request to the server.

3. The roadside unit according to claim 1, wherein the control circuitry receives re-upload information from the server through the communication circuitry, and transfers the re-upload information to the on-board unit, the re-upload information including information indicative of an uploaded data volume of the data.

4. The roadside unit according to claim 1, wherein in a case where communication with the server is disconnected and a timeout occurs, the control circuitry transfers the upload resume request to the server through the communication circuitry.

5. The roadside unit according to claim 1, wherein in a case where the control circuitry suspends the transfer of the upload resume request, then starts the transfer of the upload resume request, but the upload resume request is not received by the server, the control circuitry transmits an error notification to the on-board unit through the communication circuitry.

6. The roadside unit according to claim 1, wherein in a case where the control circuitry suspends the transfer of the upload resume request, the control circuitry transmits information to the on-board unit through the communication circuitry, the information being information for controlling a transmission interval of the upload resume request transmitted by the on-board unit.

7. An on-board unit, comprising:
communication circuitry, which, in operation, performs communication with a roadside unit, the roadside unit including:
transfer circuitry, which, in operation, receives data and transfers the data to a server; and
control circuitry, which, in operation, suspends, in a case where an upload resume request for the data has been received from the on-board unit while the data is being transferred to the server, transfer of the upload resume request to the server; and
control circuitry, which, in operation, configures, after the communication with the roadside unit is disconnected, a transmission interval of the upload resume request to be longer than a transmission interval of the upload resume request before the communication with the roadside unit is disconnected.

8. A communication system, comprising an on-board unit and a roadside unit, wherein:
the on-board unit includes:
on-board unit communication circuitry, which, in operation, transmits data; and
on-board unit control circuitry, which, in operation, transmits an upload resume request for the data, and
the roadside unit includes:
roadside unit communication circuitry, which, in operation, receives the data and transfers the data to a server; and
roadside unit control circuitry, which, in operation, suspends, in a case where the upload resume request for the data has been received while the data is being transferred to the server, transfer of the upload resume request to the server.

9. A communication method, comprising:
receiving data transmitted from an on-board unit;
transferring the data to a server; and
suspending, in a case where an upload resume request for the data has been received from the on-board unit while the data is being transferred to the server, transfer of the upload resume request to the server.
